(19) United States
(12) Patent Application Publication
(10) Pub. No.: US 2005/0000484 A1
(43) Pub. Date: Jan. 6, 2005

(54) Pre-chambered type spark plug with a flat bottom being aligned with a bottom surface of a cylinder head

(76) Inventors: James M. Schultz, Chillicothe, IL (US); Brady L. Winkleman, Lafayette, IN (US); Jason L. Niethammer, Lafayette, IN (US); William C. Boley, Lafayette, IN (US)

Correspondence Address: CATERPILLAR INC.;100 N.E. ADAMS STREET, PATENT DEPT., PEORIA, IL, 616296490, US

(21) Appl. No.: 10/613,687

(22) Filed: Jul. 3, 2003

(51) Int. Cl. F02B 19/12; H01T 13/54

(52) U.S. Cl. 123/266; 313/143

(57) ABSTRACT

The present spark plug is of the encapsulated design and facilitates the life of the spark plug, enhances the combustion process and reduces emissions. The position of the spark plug is substantially within a cylinder head external of a combustion chamber of an engine and close to a cooling passage which reduces the heat transferred to the spark plug and increases the life of the spark plug. The configuration or design of the spark plug makes the manufacturing process less costly and facilitates the combustion process by using one of a single orifice or a plurality of orifices positioned at and in a preestablished manner. The configuration will reduce or eliminate pre-ignition and other detonation problems enabling the timing to be advanced further reducing emissions.

### TECHNICAL FIELD

This invention relates generally to a spark ignition device and more particular to a pre-chamber type spark plug.

### BACKGROUND

Emissions and efficiency continue to drive technology to improve combustion of air and fuel mixtures. Many improvements control the air and fuel mixture. Examples of some combustion of air and fuel mixtures improvements include improved combustion chamber design, valve porting and fuel or air flow and atomization process. These improvements all generally improve control of the fuel and air mixture.

Unlike in a diesel cycle engine, spark ignited engines may also control a combustion event through initiation of a spark. Encapsulated spark plugs have shown an improvement gained from improving conditions and mixing of fuel and air along with an improvement gained by controlling initiation of the spark. The encapsulated spark plug includes a plug shell surrounding an electrode gap. The plug shell defines an ignition chamber separated from a combustion chamber. An orifice or orifices are positioned in the plug shell interconnecting the ignition chamber with the combustion chamber. The ignition chamber and the plug shell separates a flame kernel from turbulence in the combustion chamber. As a piston compresses and air and fuel mixture within the combustion chamber, at least a portion of the air and fuel mixture passes through the orifices into the ignition chamber.

In the ignition chamber, a spark causes the air and fuel mixture to combust creating a pressure rise. As the pressure in the ignition chamber increases and overcomes the pressure within the combustion chamber, hot gasses pass through each orifice into the combustion chamber and act as an ignition torch increasing the combustion rate in the combustion chamber to reduce the masses of unburned air and fuel mixture. U.S. Pat. No. 5,105,780 issued on Apr. 21, 1992 to Ronald D. Richardson defines one such encapsulated spark plug.

Although the encapsulated spark plug has been shown to increase efficiency and reduce emissions other drawbacks tend to reduce their use. For example, the encapsulated spark plug experiences an increased temperature environment, thus, reducing its life over a conventional spark plug. The encapsulated spark plug which protrudes into the combustion chamber causes pre-ignition and other detonation problems. In a lean air and fuel mixture the voltage needed to jump an electrode gap between an electrode and ground electrode required results in an increased voltage due to break down in the voltage. The increased break down voltages requires a greater electrical insulation between the electrode and ground electrode. The increased electrical insulation often means increasing a heat transfer path between a capsule connected to the ground electrode and cool environment. Further exacerbating wear, the orifices through the plug shell experience extreme temperature changes. Hot gas exits the ignition chamber through the orifices at high velocities. These high velocities increase heat transfer from the hot gases to the plug shell decreasing life of the encapsulated spark plug. Additionally, resistance such as welds used to attache the plug shell to the plug hinders heat transfer away from the orifices.

The present invention is directed to overcoming one or more of the problems as set for the above.

### SUMMARY OF THE INVENTION

In one aspect of the present invention, a spark ignited engine comprises a block having a top surface and a cylindrical bore therein. A piston is movably positioned in the cylindrical bore. A cylinder head has a bottom surface and is attached to the block. A combustion chamber is defined by the cylindrical bore, the piston and the bottom surface of the cylinder head. A spark plug has an electrode, a plug shell, a plug shell cap and an insulator. The spark plug is positioned in the cylinder head. The spark plug is of an encapsulated configuration defining an ignition chamber. And, the spark plug is substantially positioned within the cylinder head and substantially external of the combustion chamber.

In another embodiment of this invention, a spark plug comprises an electrode being an electrical conductor and having a heat resistance. An insulator is operatively positioned about the electrode and maintains a structural integrity in a high temperature environment. A plug shell is operatively connected to the electrode and has an insulator region, a connection region and a tip and orifice portion. The tip and orifice portion has an ignition chamber therein and has a bottom plane portion defining a substantially flat outer contour.

### BRIEF DESCRIPTION OF THE DRAWINGS

FIG. 1 is a cross section view of a spark ignited internal combustion engine having a spark plug positioned therein;

FIG. 2 is an enlarged partially cross sectioned view of a spark plug having an embodiment of the present invention;

FIG. 3 is a bottom view of the spark plug of FIG. 2;

FIG. 4 is an enlarged partially cross sectioned view of a spark plug having an embodiment of the present invention;

FIG. 5 is a bottom view of the spark plug of FIG. 4; and

FIG. 6 is a bottom view of another alternative spark plug.

### DETAILED DESCRIPTION

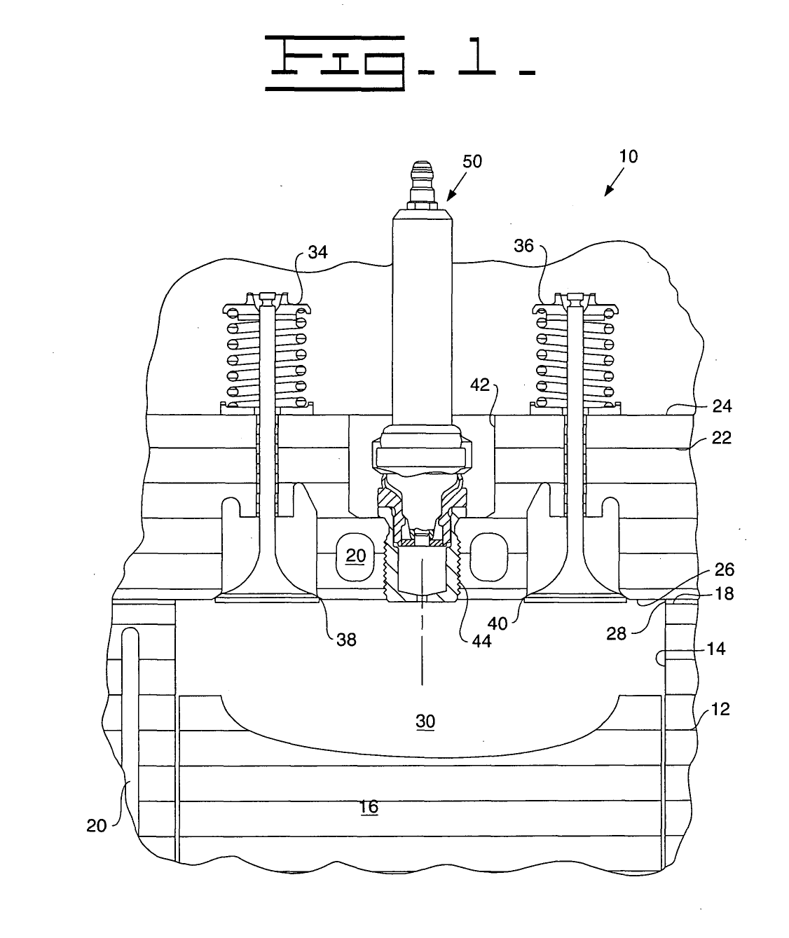

In FIG. 1, a spark ignition engine 10 is partially shown. The engine 10 includes a block 12 having a cylinder bore 14 therein. A piston 16 of conventional design is movably positioned within the cylinder bore 14 in a conventional manner. The block 12 defines a top surface 18. The block 12 has a plurality of cooling passages 20 therein of which only one is shown. A conventional cooling system, not shown, circulates a coolant through the plurality of cooling passages 20.

A cylinder head 22 defines a top surface 24 and a bottom surface 26. The bottom surface 26 of the cylinder head 22 is removably attached to the top surface 18 of the block 12 in a conventional manner such as by a plurality of bolts, not shown. The plurality of cooling passages 20 are also positioned in the cylinder head 22 at preestablished positions. A gasket 28 is normally interposed the top surface 18 of the block 12 and the bottom surface 26 of the cylinder head 22. Thus, a combustion chamber 30 is defined between the bottom surface 26 of the cylinder head, the cylinder bore 14 of the block and the piston 16. The cylinder head 22 has at least one intake valve mechanism 34 operatively positioned therein and at least one exhaust valve mechanism 36 operatively positioned therein. An intake sealing portion 38 of the intake valve mechanism 34 is positioned near the bottom surface 26. And, an exhaust sealing portion 40 of the exhaust valve mechanism 36 is positioned near the bottom surface 26. In this application, the intake valve mechanism 34 and the exhaust valve mechanism 36 are operated by a cam, follower and push rod mechanism, not shown. The intake valve mechanism 34 and the exhaust valve mechanism 36 could be operated by other means such as hydraulic or electrical without changing the gist of the design. A stepped through bore 42 is positioned in the cylinder head 22 and extends between the top surface 24 and the bottom surface 26. With the cylinder head 22 positioned on the block and in this application, the stepped through bore 42 is centered about the cylinder bore 14. As an alternative, the stepped through bore 42 could be positioned in any manner about the cylinder bore 14. The stepped through bore 42 includes a fastening mechanism 44 of conventional design, such as a threaded portion of a wedge portion. The plurality of cooling passages 20 are operatively positioned in the cylinder head 22. One of the plurality of cooling passages 20 is positioned in heat exchanging relationship to the stepped through bore 42. The convention cooling system also circulated the coolant through the plurality of cooling passages 20 in the cylinder head 22.

As further shown in FIG. 2, a spark plug 50 or sparking means or means for igniting a combustible mixture is positioned in the stepped through bore 42. In this application, the spark plug 50 is of the encapsulated design. The spark plug 50 has a connecting portion 52 or connecting means which in this application is a threaded connector. The connecting portion 52 and the fastening mechanism 44 of the stepped through bore 42 must be capable of withstanding pressure, temperature and chemistry compatibility typical of a combustion process. The spark plug 50 is sealingly connected with the cylinder head 22 in a conventional manner.

In FIG. 2, the spark plug 50 is shown partially sectioned and at a larger scale. The spark plug 50 includes a plug shell 54, insulator 56, and an electrode 60. The electrode 60 can also be a means for conducting an electrical discharge. And, the insulator 56 can be a means for insulating. The electrode 60 is made of a material having good electrical conductivity and heat resistance such as a nickel alloy. The insulator 56 operatively electrically isolates the electrode 60 and maintains structural integrity in a high temperature environment. One such material for making the insulator 56 is a ceramic material. The insulator 56 connects and covers the electrode 60. The plug shell 54 has an insulator retention region 70, a connection region 72, and a tip and orifice portion 74. The tip and orifice portion 74 has at least one orifice 76 therein. For example, as shown in FIG. 2, a single orifice 78 is shown. The single orifice 78, in this application, has an axis, designated by a reference numeral 80, which is axially aligned with an axis of the cylindrical bore 14 of the block 12. The single orifice 78 has a preestablished size which in this application is cylindrical and has a diameter being 1.68 mm or between about 1 mm and 2 mm. Another diameter or diameters can be used without departing from the essences of the design. The tip and orifice portion 74 defines a bottom plane portion 82 which with the spark plug 50 positioned in the cylinder head 22 is aligned with the bottom surface 26 of the cylinder head. However, with the stack up of tolerances, the bottom plane portion 82 of the spark plug 50 may extend slightly beyond the bottom surface 26 of the cylinder head 22 into the combustion chamber 30. Or with the stack up of tolerances, the bottom plane portion 82 of the spark plug 50 may extend slightly inside of the bottom surface 26 of the cylinder head 22 away from the combustion chamber 30. With the present design, the stack up of tolerances can vary the position of the bottom plane portion 82 plus or minus about 2 mm. However, it is contemplated that the position of the bottom plane portion may vary about plus or minus about 4 mm without changing the operation of the spark plug 50 and the engine 10. Thus, making substantially the entire spark plug above the combustion chamber 30. The tip and bottom portion 74 is in closest proximity to the combustion chamber 30. The plug shell 54 is made from a material having high thermal conductivity, high thermal stability, and resistance to environmental corrosion in high temperature up to 1150 C. Ideally a nickel alloy containing about 99% by weight nickel could be used. Similarly, corrosion resistant surface treatments may provide corrosion resistance.

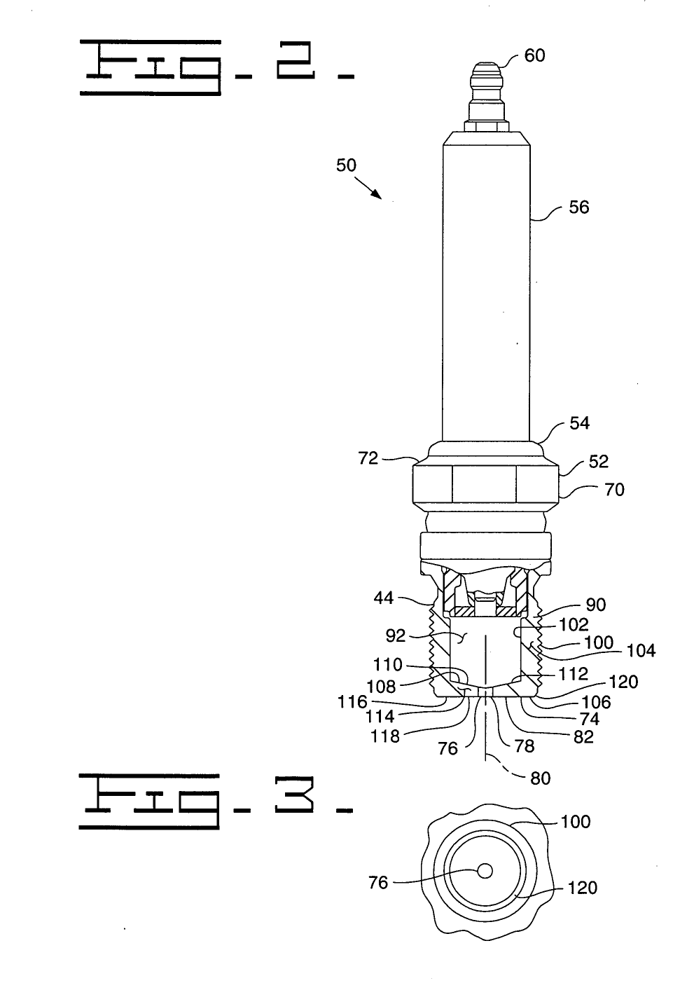

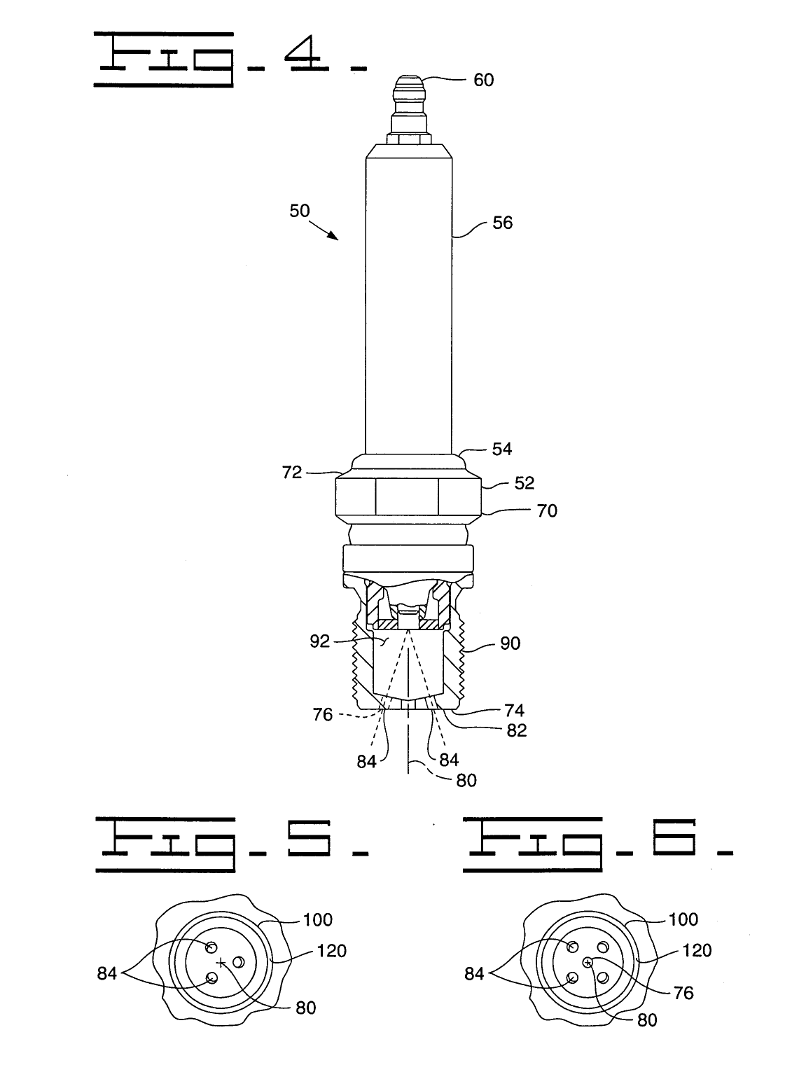

As an alternative, the tip and orifice portion 74 could have more than at least one orifice 76. For example, as shown in FIGS. 4 and 5, a plurality of orifices 84 are shown. In this application three orifices are shown having a preestablished size which in this application is cylindrical and has a diameter being 1.07 mm or between about 1 mm and 2 mm. Another diameter or diameters can be used without departing from the essences of the design. With the plurality of orifices 84 the each of the orifices 84 are equally spaced from the axis 80 in a conical manner having a centerline being at about a 15 degrees angle to the axis 80. The apex of the conical centerline being at or below the electrode 60. FIG. 6, also discloses a plurality of orifices 84 in the spark plug 50. The design shown is a combination of that disclosed in FIGS. 2 and 3 and that disclosed in FIGS. 4 and 5. For example, the single orifice 78, in this application, has the axis, designated by the reference numeral 80, axially aligned with the axis of the cylindrical bore 14 of the block 12. The single orifice 78 has a preestablished size which in this application is cylindrical. And, in this alternative five orifices are shown having a preestablished size which is cylindrical. With the plurality of orifices 84, each of the orifices 84 are equally spaced from the axis 80 in a conical manner having a centerline being at about a 15 degrees angle to the axis 80. The apex of the conical centerline being at or below the electrode 60. Other combination of the plurality of orifices 84 can be contemplated, for example, a combination of four or six or seven or more orifices 84 could be used and the single orifice 78 centered on the axis 80 could be eliminated if desired.

A plug shell cap 90 is sealingly connected to the tip and orifice portion 74 of the spark plug shell 54. The plug shell cap 90, the plug shell 54, and the insulator 56 define an ignition chamber 92. Thus, the plug shell cap 90 the plug shell 54 and the insulator 56 form a means for defining the ignition chamber 92. In this application, the ignition chamber 92 has a preestablished chamber volume of about 1000 mm. However, depending on the displacement of the combustion chamber 30 the chamber volume of the ignition chamber 92 will be optimized or varied. A larger combustion chamber 30 will have a larger ignition chamber 92 volume and a smaller combustion chamber 30 will have a smaller ignition chamber 92 volume. In this application, the plug shell cap 90 is connected to the tip and orifice portion 74 by a full depth conventional TIG welding process. Other conventional connection methods such as brazing may also be used so long as the resulting method withstands the high temperature and high pressure environment. For example, the plug shell cap 90 may be connected to the tip and orifice portion 74 by a press fit or threadedly connected. The plug shell cap 90 may be made from a second material having high thermal conductivity, high thermal stability, and resistance to environmental corrosion in high temperatures up to 1150 C. In this application, the first material and second material are the same. However, the first material and the second material may be different without changing the gist of the spark plug 50.

The plug shell cap 90 has a substantially cylindrical outer contour 100 and a substantially cylindrical inner contour 102 between which is formed a wall thickness 104. The outer contour 100 and the inner contour 102 are substantially parallel one to the other. The bottom plane portion 82 of the tip and orifice portion 74 has a substantially flat outer contour 106. And, an inner contour 108 of the bottom plane portion 82 has one of a radiused contour 110 or an angled contour 112. Thus, a wall thickness 114 is formed between the flat outer contour 106 and the inner contour 108 of the bottom plane portion 82. With one of the radiused contour 110 or the angled contour 112 the wall thickness 114 is thicker near an outer portion 116 being adjacent the substantially cylindrical inner contour 102 of the plug shell cap 90 than is the wall thickness 114 near a center portion 118 being near the axis 80 or the axis of the cylinder bore 14. As an alternative, the wall thickness 114 could be uniform from the outer portion 116 to the center portion 118. Thus, in this embodiment, the ignition chamber 92 has a cylindrical outer profile, a flat top profile, and a radiused or angled bottom profile. Positioned between the outer contour 100 of the plug shell cap 90 and the flat outer contour 106 of the bottom plane portion 82 is a chamfer 120. The chamfer 120 is deburred and polished to remove any sharp corners.

Other configurations of the contours making up the above plug shell cap could be used without changing the gist of the invention; however, in this application the configurations as defined are intended to enhance the manufacturing process, increase the longevity of the spark plug 50 and reduce emission emitted from the engine 10. Experimentation has shown that the configuration will reduce or eliminate pre-ignition and other detonation problems enabling the timing to be advanced further reducing emissions.

Industrial Applicability

In operation, the spark plug 50 is positioned in the cylinder head 22. In this application, the spark plug 50 is threadedly attached with the fastening mechanism 44 of the cylinder head 22. The plug shell 54 is substantially positioned in the cylinder head 22 and only a small portion of the tip and orifice portion 74 extends into the combustion chamber 30 of the engine 10. For example, only the chamfered portion 120 is within the combustion chamber 30 and the remainder of the spark plug 50 is positioned within the cylinder head 22 externally of the combustion chamber 30.

With the position of the spark plug 50 substantially within the cylinder externally of the combustion chamber 30 less heat from the combustion within the combustion chamber 30 is transferred to the plug shell 54 of the spark plug 50. And, with the spark plug 50 positioned substantially within the cylinder head 22 near the cooling passage 20 less heat is transferred from the combustion process and heat is more easily transmitted to the coolant within the cooling passage 20. Thus, the life of the spark plug 50 is extended. And, experimentation has shown that the configuration will reduce or eliminate pre-ignition and other detonation problems enabling the timing to be advanced further reducing emissions.

The construction of the plug shell 54 of the spark plug 50 makes for easy manufacturing reducing cost and enhances the combustion process reducing emissions. For example, the cylindrical outer contour 100 and the cylindrical inner contour 102 of the plug shell cap 90 provides easy manufacturing of both the spark plug 50 and the bore 42 within the cylinder head 22. The flat outer contour 106 of the bottom plane portion 82 and the radiused contour 110 or angled contour 112 of the inner contour 108 enables a cost effective manufacturing process for making the bottom plane portion 82. And, with the bottom plane portion 82 and the plug shell cap 90 being separate components the manufacturing process is enhanced. As an alternative, however, the components could be made from one piece and the welding process eliminated. However, with the position of the bottom plane portion 82 in heat transfer relationship with the combustion chamber 30 of the engine 10 the ability to use a different material, higher heat resistance, facilitates the use of separate components. And, with the majority of the plug shell cap 90 positioned within the cylinder head 22 near the cooling passage 20 and external of the combustion chamber further facilitates the use of separate components.

It is anticipated that the single orifice 76 being aligned with the axis 80 and the axis of the combustion chamber will enhance the combustion process. And, with the use of a plurality of orifices 84 being positioned equal distance from the axis 80 in a conical manner having a centerline of about 15 degrees and being evenly spaced therebetween will enhance the combustion process. It is further contemplated that the radiused contour 110 or angled contour 112 of the inner contour 108 of the bottom plane portion 82 will enhance the combustion process within the ignition chamber 92 and thus the combustion chamber 30 of the engine 10.

Thus, the embodiment of the present spark plug 50 enhances the manufacturing of the spark plug 50, the longevity of the spark plug 50 and the efficiency of the resulting ignition of the combustion chamber 30 reducing emissions. And, experimentation has shown that the configuration will reduce or eliminate pre-ignition and other detonation problems enabling the timing to be advanced further reducing emissions.

Other aspects, objects and advantages of this invention can be obtained from a study of the drawings, the disclosure, and the appended claims.

1. A spark ignited engine; said engine comprising:
a block having a top surface and a cylindrical bore therein;
a piston being movably positioned in said cylindrical bore;
a cylinder head having a bottom surface and being attached to said block;
a combustion chamber being defined by said cylindrical bore, said piston and said bottom surface of said cylinder head;
a spark plug having an electrode, a plug shell, a plug shell cap and an insulator, said spark plug being positioned in said cylinder head;
said spark plug being of an encapsulated configuration defining an ignition chamber; and
said spark plug being substantially positioned within said cylinder head and substantially external of said combustion chamber.

2. The spark ignited engine as defined in claim 1 wherein said plug shell defines a cylindrical outer contour being connected to a bottom plane portion having a flat outer contour.

3. The spark ignited engine as defined in claim 1 wherein said ignition chamber defines a cylindrical outer profile, a flat top portion and one of a radiused and a flat and an angled bottom profile.

4. The spark ignited engine as defined in claim 1 wherein said ignition chamber has at least a single orifice exiting therefrom through a bottom plane portion having a flat outer contour and into said combustion chamber.

5. The spark ignited engine as defined in claim 4 wherein said single orifice is positioned about an axis, said axis being aligned with an axis of said combustion chamber.

6. The spark ignited engine as defined in claim 1 wherein said ignition chamber has a plurality of orifices exiting therefrom through a bottom plane portion having a flat outer contour and into said combustion chamber.

7. The spark ignited engine as defined in claim 6 wherein said plurality of orifices are position about an axis, said axis being aligned with an axis of said combustion chamber.

8. The spark ignited engine as defined in claim 7 wherein each of said plurality of orifices are positioned at an equal distance from said axis and at an equal angular relationship.

9. The spark ignited engine as defined in claim 1 wherein said ignition chamber has one of a radiused and a flat and an angled bottom profile, said plug shell defines a bottom plane portion having a flat outer contour and a wall thickness formed therebetween has a wall thickness being thicker near an outer portion than at a center portion.

10. A spark plug comprising:
an electrode being an electrical conductor and having a heat resistance;
an insulator being operatively positioned about the electrode and maintaining structural integrity in a high temperature environment;
a plug shell being operatively connected to the electrode and having an insulator region, a connection region and a tip and orifice portion, said tip and orifice portion having an ignition chamber therein and having a bottom plane portion defining a substantially flat outer contour.

11. The spark plug as defined in claim 10 wherein said plug shell defines a cylindrical outer contour being connected to said bottom plane portion.

12. The spark plug as defined in claim 10 wherein said ignition chamber has a cylindrical outer profile, a flat top profile and one of a radiused and a flat and an angled bottom profile.

13. The spark plug as defined in claim 12 wherein one of said radiused and flat and angled bottom profile has a opening therein.

14. The spark plug as defined in claim 13 wherein said opening is positioned about an axis.

15. The spark plug as defined in claim 13 wherein one of said radiused and flat and angled bottom profile has a plurality of openings therein.

16. The spark plug as defined in claim 15 wherein each of said plurality of openings are positioned about an axis at an equal distance therefrom and at an equal angular relationship.

17. The spark plug as defined in claim 10 wherein said bottom plane portion has a wall thickness being thicker near an outer portion than at a center portion.

18. A method of positioning a spark plug within a cylinder head of an engine; said method comprising the steps of:
inserting said spark plug removably within said a cylinder head of said engines;
positioning said spark plug substantially within said cylinder head; and
having an ignition chamber of said spark plug in heat exchanging relationship with a cooling passage in said cylinder head.

19. The method of positioning a spark plug within a cylinder head of an engine as defined in claim 18 wherein said ignition chamber of said spark plug is external of a combustion chamber of said engine.

20. The method of positioning a spark plug within a cylinder head of an engine as defined in claim 18 wherein said spark plug has a bottom plane portion having a substantially flat outer contour.
